(19) United States
(12) Patent Application Publication
(10) Pub. No.: US 2016/0031119 A1
(43) Pub. Date: Feb. 4, 2016

(54) Feed Device

(71) Applicant: HILTI AKTIENGESELLSCHAFT, München (DE)

(72) Inventor: John Van TAACK-TRAKRANEN, Muenchen (DE)

(73) Assignee: Hilti Aktiengesellschaft, Schaan (LI)

(21) Appl. No.: 14/782,287

(22) PCT Filed: Apr. 3, 2014
(86) PCT No.: PCT/EP2014/056642

§ 371 Date: Oct. 2, 2015

(30) Foreign Application Priority Data
Apr. 3, 2013 (DE) 10 2013 205 827.6

(51) Int. Cl. B28D 7/00; B28D 1/14

(52) U.S. Cl. CPC B28D 7/005; B28D 1/14

(57) ABSTRACT

A method for using a feed device for driving a machine tool, particularly for driving a core drill bit for drilling concrete and masonry, along a machine base is disclosed. A feed device for using this method, where there is included a drive for reversibly driving the machine tool relative to the machine base and sensors for recording the parameters of the machine tool and the parameters of the feed device, is also disclosed. A machine tool for using this method, where there is included a drive for driving a tool held in the machine tool, is further disclosed. In the method, a parameter for the machine tool and/or the feed device that is optimal for working on an existing workpiece is adjusted on the basis of at least one measured parameter of the machine tool as well as at least one measured parameter of the feed device.

This application claims the priority of International Application No. PCT/EP2014/056642, filed Apr. 3, 2014, and German Patent Document No. 10 2013 205 827.6, filed Apr. 3, 2013, the disclosures of which are expressly incorporated by reference herein.

### BACKGROUND AND SUMMARY OF THE INVENTION

The present invention relates to a method for using a feed device for driving a machine tool, particularly for driving a core drill bit for drilling concrete and masonry, along a machine base.

In addition, the invention relates to a feed device for a method for using a feed device for driving a machine tool, particularly for driving a core drill bit for drilling concrete and masonry, along a machine base. The feed device thereby includes a drive for reversibly driving the machine tool relative to the machine base as well as at least one sensor for recording the parameters of the machine tool and the parameters of the feed device.

Furthermore, the invention relates to a machine tool for a method for using a feed device for driving a machine tool, particularly for driving a core drill bit for drilling concrete and masonry, along a machine base. The machine tool thereby includes a drive for driving a tool held in the machine tool.

The high torques and feed forces required when core-drilling stone are typically applied by the machine tool or core drilling machine against a machine base that is rigidly connected to the substrate. The forces generated by the machine tool are symmetrically transferred, via a displaceable guide carriage designed with a machine-coupling part for centrally attaching the machine tool, to a guide rail and then via a ground plate into the substrate. The forces required for feeding the machine tool are generated in particular by a feed device, which can be operated manually and/or by machine. For example, using a manually operated handwheel, which is connected via a spindle to the feed device, the machine tool can be moved reversibly along a toothed rack to thereby drive the core drill bit driven by the machine tool into a substrate to be worked on. Alternatively, the feed device can also be equipped with a machine drive. This machine drive can for example be constructed in an electric, hydraulic, or also pneumatic form.

Such a device is known for example from EP 2 067 578, wherein a transportable machine tool is disclosed in particular, which serves as a drive for a core drill bit for drilling concrete and masonry. The machine tool is attached by means of a machine coupling to a guide carriage. The guide carriage is in turn displaceable along a vertically or horizontally oriented machine base, whereby the machine tool along with the core drill bit can also be displaced vertically. By displacing the machine tool, the core drill bit driven by it can penetrate into the substrate being worked on and bore a hole.

When operating a core drill machine, the parameters for the desired feed, i.e., start position, feed rate, end position, drill depth, etc. are adjusted manually via a terminal or display on the feed device prior to startup. Alternatively, the parameters for the desired feed can also stem from a signal, which in turn can be generated by a mains cable of the drill motor belonging to the machine tool, the cable being looped through via the feed device to the drill apparatus.

In addition, the parameters of the core drill machine, e.g., the rotational speed, the torque, the applied power, etc. are entered manually by means of a corresponding terminal on the core drill machine prior to startup. The parameters are often selected relative to the material to be worked on, i.e., the substrate to be drilled into.

These feed devices used to date, which can draw either only a manual parameter adjustment or the feed parameters from the signal of a looped-through drill motor mains cable, have in particular the disadvantages that the drill motor of the core drill machine cannot by itself take into account changing drill conditions, e.g., harder sections in the substrate, during the drilling process and an ideal drilling process can thereby not be achieved.

In addition, such an apparatus as well as a hereto corresponding method for operating a machine tool, e.g., a core drill machine, is depicted in published patent application DE 10 2007 021 070. The core drill machine disclosed in this prior art document and the associated method distinguish themselves in that based on the motor output as well as the value determined from this for specifying the feed rate, an estimate is performed regarding a parameter characterizing the tool as well as a parameter characterizing the workpiece to be worked on. The disadvantage is that on the one hand, the feed rate of the tool is determined on the basis of only one actual parameter, namely the motor output of the rotary drive at the time, and on the other or based on that, only an estimate for the tool parameter is produced (e.g., in the form of drill bit diameter) from a stored reference database. The hereby generated tool parameters can hereby only be adjusted in a relatively rough manner, whereby the entire drill process can only be adjusted contingent on changing drilling conditions, and thereby be operated in a suboptimal manner.

The objective of the present invention consists of providing a method for using a feed device for driving a machine tool, particularly for driving a core drill bit for drilling in cement and masonry, along a machine base. In addition, the objective of the present invention also consists of providing a feed device, a machine tool, as well as a machine base for this method.

By means of this method according to the invention as well as the feed device according to the invention as well as the machine tool according to the invention, the aforementioned disadvantages are avoided and the core drilling process is designed more efficiently.

Accordingly, a method is provided for using a feed device for driving a machine tool, particularly for driving a core drill bit for drilling in cement and masonry, along a machine base.

In addition, a feed device is provided for a method for using a feed device for driving a machine tool, particularly for driving a core drill bit for drilling in cement and masonry, along a machine base, wherein the feed device thereby includes a drive for reversibly driving the machine tool relative to the machine base as well as at least one sensor for recording the parameters of the machine tool and the parameters of the feed device.

Furthermore, a machine tool is provided for a method for using a feed device for driving a machine tool, particularly for driving a core drill bit for drilling in cement and masonry, along a machine base.

According to the invention and in this method, an optimal parameter for working on an existing workpiece is adjusted for the machine tool and/or the feed device, based on at least one measured parameter of the machine tool as well as at least one measured parameter of the feed device.

The parameters of the feed device and the machine tools are hereby better readjusted in the course of the drilling process and the entire drilling process is better adjusted to changing drilling conditions, particularly when encountering embedded steel.

According to an advantageous embodiment of the present invention, it may be provided that a predetermined number of measured parameters of the machine tool and/or the feed device are recorded to store and analyze these in a corresponding memory apparatus.

In addition, adjusting the optimal parameter for the machine tool and/or the feed device may occur using the trend derived from the change in the recorded parameters of the machine tool and/or the feed device, whereby one can respond to future changes or deviations of the parameters accordingly. Optimal parameters refer to parameters that enable one to perform the drilling process as quickly and efficiently as possible.

According to another advantageous embodiment of the present invention, one can use as a machine tool a core drilling machine into which a core drill bit can be inserted, and one can select the diameter of the core drill bit as at least one parameter of the machine tool.

Furthermore, it may be advantageously provided that a parameter characterizing the hardness of the workpiece is selected for adjusting the optimal parameter for the machine tool and/or the feed device. Optimal parameters refer to parameters that allow one to perform the drilling process as quickly and efficiently as possible.

According to an advantageous embodiment of the feed device according to the invention, a first control unit or a second control unit may be provided for adjusting the optimal parameter of the machine tool and/or the feed device for working on an existing workpiece. Optimal parameters thereby refer to parameters that allow one to perform the drilling process as quickly and efficiently as possible.

In addition, the first control unit or the second control unit may be integrated at least partially in the machine tool. By a differing and particularly variable allocation or arrangement of the first or second control unit, a plurality of cost- and space-saving designs of the machine tool and/or feed device can be realized.

According to an advantageous embodiment of the machine tool according to the invention, a first control unit or a second control unit may be provided for adjusting the parameter, which is optimal for working on an existing workpiece, for the machine tool and/or feed device. Optimal parameters thereby refer to parameters that allow one to perform the drilling process as quickly and efficiently as possible.

It is thereby possible that at least the first control unit or the second control unit is integrated at least partially in the feed device. By a differing and particularly variable allocation or arrangement of the first or second control unit, a plurality of cost- and space-saving designs of the machine tool and/or feed device can be realized.

The invention is explained in further detail in regard to advantageous embodiments.

### BRIEF DESCRIPTION OF THE DRAWINGS

FIG. 1 illustrates a feed device according to the invention, a machine tool according to the invention, and a machine base according to a first embodiment;

FIG. 2 illustrates a feed device according to the invention, a machine tool according to the invention, and a machine base according to a second embodiment; and

FIG. 3 illustrates a connection of the feed device according to the invention to the machine tool according to the invention.

### DETAILED DESCRIPTION OF THE DRAWINGS

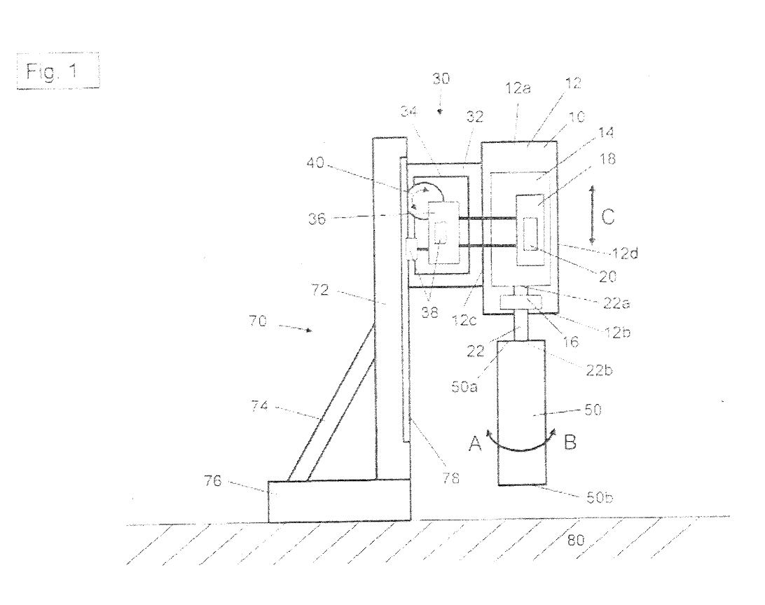

FIG. 1 depicts a combination of a machine tool 10, a feed device 30, a drilling tool 50, and a machine base 70.

Machine tool 10 is designed as a core drilling machine and includes a housing 12, a drive 14, a gearbox 16, a first control unit 18, sensors 20, and a drive shaft 22. Drive 14 is in the form of an electric motor. Alternatively, any other suitable drive type may be chosen. According to a special embodiment of the present invention, drive 14 may be formed by a high-frequency motor. The first control unit 18 is designed in such a manner that it records all parameters of machine tool 10 and particularly all parameters of drive 14, which are measured by sensors 20 of machine tool 10. These parameters include for example the engaged gear of gearbox 16, the rotational speed, the torque, the applied and/or emitted output of drive 14, etc. Housing 12 has a top side 12a, a bottom side 12b, a left side 12c, and a right side 12d. Drive 14 is located inside housing 12. Drive shaft 22 has a first end 22a and a second end 22b. The first end 22a of drive shaft 22 is connected to drive 14 in such a manner that drive 14 can place drive shaft 22 into motion in a first rotational movement A or second rotational movement B. The second end 22b of drive shaft 22 protrudes out of core drilling machine 10 at the bottom side 12b of housing 12. In addition, drilling tool 50 has a first end 50a in the shape of a cylindrical drill bit and a second end 50b. The first end 50a of drilling tool 50 is connected to the second end 22b of drive shaft 22 in a rotationally fixed manner. Via drive shaft 22, machine tool 10 can place drilling tool 50 into the first rotational movement A or into the second rotational movement B.

Feed device 30 includes a housing 32 in which a feed device 34, a second control unit 36, sensors 38 as well as a drive pinion 40 are positioned. The second control unit 36 is designed in such a manner that it records all parameters of feed device 30 and in particular the parameters of feed drive 34, which are measured by sensors 38 of feed device 30. These measured parameters include for example the feed rate of feed device 30 relative to machine base 70, the already traveled distance of feed device 30 since starting the drilling process, the position of feed device 30 along machine base 70, the rotational angle of feed drive 34, etc. In addition, a plurality of parameters can be calculated by control unit 36 of feed device 30. The parameter calculation thereby takes place by means of a comparison between the parameters recorded by sensors 38, such as the rotation angle of drive pinion 40, and the specified (i.e., preset) parameters. From the parameter calculation, one can determine among other things the feed rate of feed device 30 relative to machine base 70, the relative and/or absolute position of feed device 30, the already traveled distance of feed device 30 since starting the drilling process as well as the time and/or the distance until reaching the stop of drilling tool 50.

Feed drive 34 is thereby designed, as depicted in FIG. 1, according to a first embodiment in the form of an electric motor.

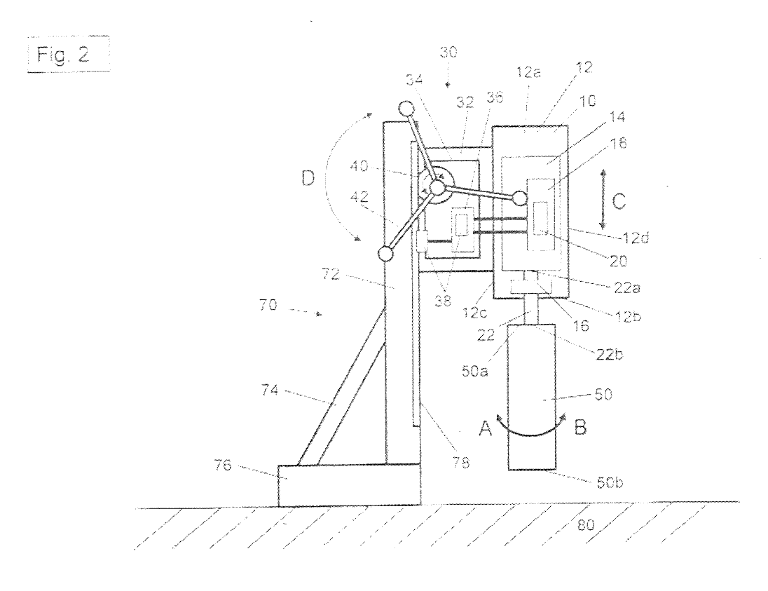

As depicted in FIG. 2, feed drive 34 can also be designed according to a second embodiment in the form of a handwheel 42.

Under the control of control unit 36, feed drive 34 drives drive pinion 40. According to the alternative design depicted in FIG. 2, feed drive 34 can also be moved in a hand-operated manner, i.e., by manually turning handwheel 42. The automatic feed of feed drive 34 is hereby turned off, whereby only the user of the feed device controls the feed. In manual mode, sensors 20, 38 can also continue to record, like the Hall sensors on drive 14, the parameters (e.g., position parameters) of feed device 30 as well as machine tool 10.

Feed device 30 is designed in such a manner that it can be mounted on machine base 70 (as described below) and can be moved along machine base 70 in arrow direction C by means off drive pinion 40. Sensors 38 are in the form of angle, rotating angle, acceleration, speed, or position sensors, and thereby designed that these record the acceleration, feed rate, angle, rotating angle, as well as the position of feed device 30, either incrementally directly at feed drive 34 or absolutely along machine base 70.

Machine base 70 includes a guide rail 72, a bracing element 74, as well as a baseplate 76. Guide rail 72 is positioned on baseplate 76 and supported by bracing element 74 in such a manner that guide rail 72 is oriented vertically or in the specified angle. In addition, guide rail 72 has on one side a toothed rack 78. Bracing element 74 is thereby optional and can, according to an alternative embodiment of the machine base, also be omitted.

As also illustrated in FIG. 1, housing 12 of machine tool 10 is attached to housing 32 of feed device 30.

Feed device 30 is mounted on machine base 70 in such a manner that drive pinion 40 of feed device 30 engages in toothed rack 78 of machine base 70. When, under the control of control unit 36, feed drive 34 places drive pinion 40 into a rotational motion, feed device 30 is moved reversibly along machine base 70 in arrow direction C. Because machine tool 10 is attached to feed device 30, the movement of feed device 30 along machine base 70 in arrow direction C also causes machine tool 10 to move along machine base 70 along arrow direction C. Due to this vertical motion of machine tool 10, the drilling tool, in the form of a cylindrical drill bit, attached to machine tool 10 is advanced vertically into workpiece 80 to be worked on, i.e., into the substrate, whereby a hole is drilled into workpiece 80.

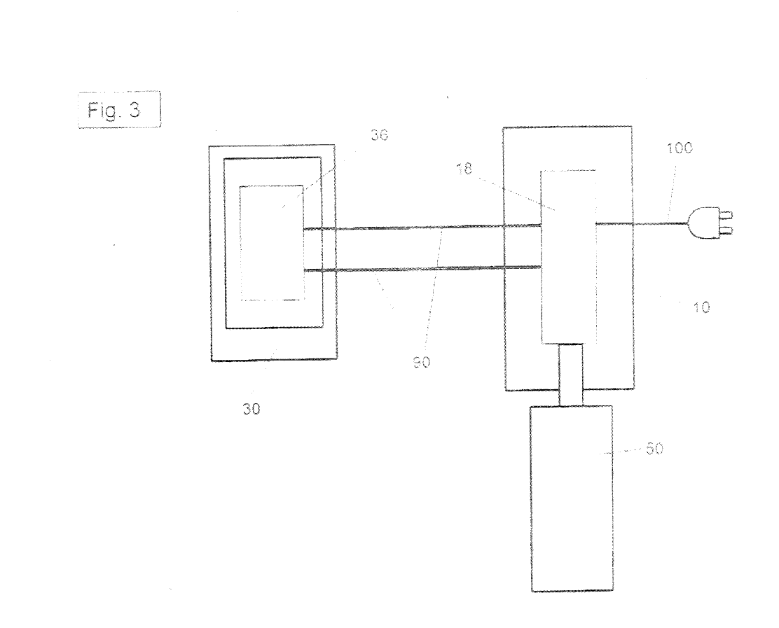

As already described precedingly, respective sensors 38 of feed device 30 measure the parameters of feed device 30. In addition, respective sensors 20 of machine tool 10 measure the parameters of machine tool 10. As illustrated in FIG. 3, feed device 30 as well as machine tool 10 are connected to each other by means of connection elements 90 in such a manner that all recordable parameter of feed device 30 can be sent to machine tool 10 and all recordable parameters of machine tool 10 can be sent to feed device 30. Thus, bidirectional communications exist between feed device 30 and machine tool 10. Based on this bidirectional communication, it is possible among other things that feed device 30 is started by means of a start switch on machine tool 10 and placed into operation.

In addition, it is possible in particular that the information flow, i.e., the bidirectional transmission of the parameters, occurs between feed device 30 and machine tool 10 using a power cable. According to an embodiment, the bidirectional transmission of the parameters by power cable 100 can occur via machine tool 10 to feed device 30.

Prior to beginning the drilling process, the parameters relevant to the pending drilling process are set for feed device 30 and machine tool 10. These parameters, e.g., feed rate, rotational speed, drill bit diameter, are often associated with workpiece 80 to be worked on and in particular with the degree of hardness of this workpiece 80 that is likely to be expected. In addition, these preset parameters (known as target parameters) are recorded or stored in the first and/or second control unit 18, 36. It is thereby possible that the adjusting of the relevant parameters for feed device 30 and machine tool 10 is only done by means of the selected drill bit diameter. The parameters relevant to the drill bit diameter, e.g., rotational speed, are stored in a software program or in a data memory device. The feed rate is then adjusted automatically or in a separate step depending on the respectively selected output setting.

During the drilling process, the respective sensors of feed device 30 and machine tool 10 measure the recordable parameters of feed device 30 and machine tool 10 (known as actual parameters), which in turn are recorded by or stored in the first and/or second control unit 18, 36.

By means of feed device 30 according to the invention, one can optimize the drilling process at any time by means of the recorded or measured parameters of feed device 30 and machine tool 10. To this end, one can, by means of first control unit 18 and/or second control unit 36, determine new target parameters from the sum of the recorded or measured parameters of feed device 30 and machine tool 10, which are optimal for the respective drilling situation, e.g., degree of hardness of workpiece 80 to be drilled. In other words, the measured actual parameters of feed device 30 and machine tool 10 result in an adjustment or optimization of one or more target parameters in feed device 30 and machine tool 10. The target parameters are thereby automatically adjusted by the first and/or second control unit 18, 36.

In this way, for example in the case of encountering reinforcement in workpiece 80 being drilled, which results in the rotational speed being reduced in drive 14 of machine tool 10, the torque of the drive can be increased correspondingly, without increasing the applied power for drive 14 of machine tool 10. One can hereby achieve an optimal feed rate of feed device 30 and machine tool 10, by means of which the entire drilling process is optimized (i.e., the drilling time is minimized).

In addition, the first and/or second control unit 18, 36 is configured in such a way that tendencies or trends in the change of the measured actual parameters can be recorded and identified as such, and that these tendencies/trends can be responded to accordingly early on by counteracting adjustments of new target parameters.

1.-11. (canceled)

12. A method for using a feed device for driving a machine tool along a machine base, comprising the steps of:
adjusting a parameter during a drilling process that is optimal for working on a workpiece for the machine tool and/or the feed device based on at least one measured parameter of the machine tool and/or the feed device.

13. The method according to claim 12, further comprising the step of recording a predetermined number of measured parameters of the machine tool and the feed device.

14. The method according to claim 13, wherein the adjusting is performed using a tendency derived from a change in the recorded parameters of the machine tool and the feed device.

15. The method according to claim 12, wherein the machine tool is a core drilling machine into which a core drill bit is insertable and wherein a diameter of the core drill bit is a measured parameter of the machine tool.

16. The method according to claim 12, further comprising the step of adjusting the parameter by a parameter characterizing a hardness of the workpiece.

17. A feed device, comprising:
a drive, wherein a machine tool is drivable relative to a machine base by the drive; and
a sensor for recording parameters of the feed device;
wherein a parameter that is optimal for working on a workpiece for the feed device is adjustable during a drilling process based on at least one measured parameter of the feed device.

18. The feed device according to claim 17, further comprising a control unit wherein the optimal parameter is adjustable by the control unit.

19. The feed device according to claim 18, wherein the control unit is integrated at least partially in the machine tool.

20. A machine tool, comprising:
a drive, wherein a tool held in the machine tool is drivable by the drive;
wherein a parameter that is optimal for working on a workpiece for the machine tool is adjustable during a drilling process based on at least one measured parameter of the machine tool.

21. The machine tool according to claim 20, further comprising a control unit wherein the optimal parameter is adjustable by the control unit.

22. The machine tool according to claim 21, wherein the control unit is integrated at least partially in a feed device.

23. An apparatus, comprising:
a feed device, including:
a feed device drive, wherein a machine tool is drivable relative to a machine base by the feed device drive; and
a sensor for recording parameters of the feed device; and
a machine tool coupled to the feed device and including:
a machine tool drive, wherein a tool held in the machine tool is drivable by the machine tool drive;
wherein a parameter that is optimal for working on a workpiece for the machine tool and/or the feed device is adjustable during a drilling process based on at least one measured parameter of the machine tool and/or the feed device.
